(19) United States
(12) Patent Application Publication
(10) Pub. No.: US 2003/0191652 A1
(43) Pub. Date: Oct. 9, 2003

(54) Customs information system with assist calculation engine

(76) Inventors: Mei Li, Gilbert, AZ (US); Theresa M. Ellis, High Point, NC (US); Edward W. Lungren, Sunnyvale, CA (US); Susan K. Porter, Clive, IA (US)

Correspondence Address: HEWLETT-PACKARD COMPANY, Intellectual Property Administration, P.O. Box 272400, Fort Collins, CO, 80527-2400, US

(21) Appl. No.: 10/115,723

(22) Filed: Apr. 3, 2002

(51) Int. Cl. G06F 17/60

(52) U.S. Cl. 705/1

(57) ABSTRACT

A system that generates customs documents for the importation of goods purchased by a buyer from a seller in a transaction. The system includes a customs information system database that includes a first set of records configured to record transaction information identifying the goods purchased, and a second set of records configured to record assist information, such as a value for assistance provided by the buyer to the seller as part of the transaction, in lieu of additional payment for the goods. The database is configured for a broker to submit a request for transaction information to be sent to create customs documents. A system routine is configured to identify all assist information associated with the transaction, and automatically send the assist information along with the transaction information. Internet interfaces provide database access for both the buyer and the broker. The buyer can indirectly enter transaction information in the first set of records via purchasing software, and directly enter assist information in the second set of records. The broker can access the first and second set of records to add or modify either type of information, as well as request that transaction information be sent.

The present invention relates generally to devices and methods of supporting import and export activity and, more particularly, to computer systems configured for tracking and supporting the generation of customs documentation.

### BACKGROUND OF THE INVENTION

In support of an international purchase made by a buyer, a customs broker will typically provide customs documentation to a local customs authority upon the entry of purchased goods into the buyer's country. This customs documentation, which typically will be in either paper or electronic form, normally indicates both a customs classification and a customs value for the imported, purchased goods. Traditionally, customs brokers generate a significant portion of the customs documentation using a commercial invoice, and other supplemental documents such as a shipping manifest, that accompanies the goods. The seller of the goods generates the commercial invoice, which they include with shipping documents that accompany the purchased goods during transport.

The commercial invoice typically indicates the cost paid by the buyer to the seller for the purchased goods. In some cases, the buyer pays a reduced cost because the buyer provides parts, materials, packaging, engineering drawings, or some other form of assistance to the buyer. While the commercial invoice does not often indicate this reduction in cost, customs laws typically require buyers to correctly value all goods. Additionally, customs laws typically require buyers to pay duties on the full value of the imported goods, rather than the reduced value paid by the buyer after giving the assistance. Apparatus and methods are therefore needed to ensure customs documents are generated in conformance with such import/export laws.

Presently, a broker and/or buyer can use customs database software to store customs information identifying goods that they purchase internationally, along with the identities of the buyer and the seller, and each of their countries. The buyer enters purchase information into purchasing software, which can select relevant portions of the information to download to the customs database. The customs software can also store classification and valuation information. A customs broker can access such customs database software to enter and modify that customs information in the database. When satisfied with the customs information, the customs broker can instruct the customs database to send a complete set of the customs information to the customs broker for customs documentation to be submitted to the customs authority.

Separately, assist database software exists for a buyer to track the values of assists provided to an international seller. This software offers a checkbook-like operation. When a customs broker receives notification that a customs authority has received a shipment for which the customs broker will serve as the broker, the customs broker takes a copy of the commercial invoice from the shipment and looks for indications that an assist has been used. In theory, the customs broker will review the Assist Database information (if it is available) for every item on the commercial invoice. However, because commercial invoices can include many different types of goods related to a single purchase (i.e., they can have many separate line items), and because a broker should research multiple types of information related to each line item (e.g., classification, assists, antidumping limitations, etc.), the large amount of work related to a single commercial invoice leads to an increased likelihood of errors caused by human error. Thus, it is not uncommon for assistance information to be incomplete in customs documentation, violating national laws.

Accordingly, there has existed a need for methods and apparatus to track and apply customs assistance information on customs documentation. Preferred embodiments of the present invention satisfy these and other needs, and provide further related advantages.

### SUMMARY OF THE INVENTION

In various embodiments, the present invention solves some or all of the needs mentioned above, providing methods and apparatus for generating customs documents for the importation of goods purchased by a buyer from a seller. The apparatus of the invention includes a system including a customs information system database. This database generally features a first set of records configured to record transaction information identifying the goods purchased. The database further features a second set of records configured to record assist information, such as a value for assistance provided by the buyer to the seller as part of the purchase of the goods, in lieu of additional payment for the goods.

Advantageously, these features provide for the system to allow either the buyer or the broker to enter and/or modify assist information. Furthermore, these features allow for using a routine configured to identify all assist information associated with a given part number and country-of-origin (as identified by a transaction), and optionally with a manufacturer ID (identification). The identified assist information can be automatically provided to the broker when the broker requests related customs information contained in the first set of records. Using such a routine, a customs broker can quickly and efficiently determine all assists that should be entered on customs documentation for a given transaction.

The system further features an internet interface providing access for both the buyer and the customs broker using typical web browsers. The system database is configured to be in electronic communication with the buyer such that the buyer can enter both transaction information in the first set of records indirectly via purchasing software used by the buyer, and assist information in the second set of records directly via a web browser. Likewise, the system database is configured to be in electronic communication with the customs broker such that the customs broker can access the first and second set of records to enter and modify information, and to generate customs documents including the transaction information and the assist information.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is a schematic representation of the interactions between participants in an international purchase of goods under the present invention.

FIG. 2 is a diagram of a communication system architecture that supports the use of a customs information system embodying the present invention.

FIG. 3 is a diagram of the record types contained within the customs information system depicted in FIG. 2.

FIG. 4 is a simplified block diagram of a menu system supporting the use of the customs information system depicted in FIG. 2.

### DETAILED DESCRIPTION OF THE PREFERRED EMBODIMENTS

The invention summarized above and defined by the enumerated claims may be better understood by referring to the following detailed description, which should be read with the accompanying drawings. This detailed description of particular preferred embodiments of the invention, set out below to enable one to build and use particular implementations of the invention, is not intended to limit the enumerated claims, but rather, it is intended to provide particular examples of them.

Typical embodiments of the present invention reside in an information system and related method for generating customs documents for the importation of purchased goods. Preferred embodiments of the invention provide for the correct customs documentation of imported goods having price discounts due to assists provided by a buyer to a seller.

The Transaction

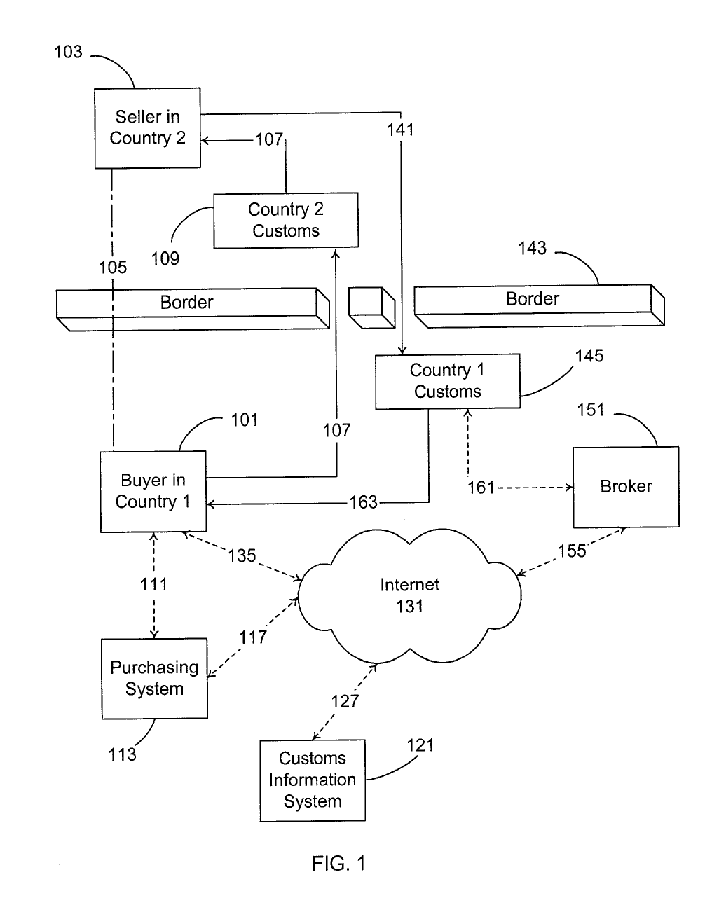

With reference to FIG. 1, in a first preferred embodiment of the invention, a buyer 101 in a first country agrees and contracts with a seller 103 in a second country to purchase goods. In the resulting agreement 105, the buyer further agrees and contracts to provide the seller with some form of assistance (hereinafter, an “assist”) in the design, development, and/or manufacture of the goods. The seller in turn agrees and contracts to sell the goods to the buyer at a price below the market price at which the seller would sell the goods to the buyer without receiving the assist.

Per this transaction, agreed upon in the agreement 105, the buyer 101 then provides the assist to the seller 103. The assist is in the form of goods and/or services supplied by the buyer directly and/or indirectly to the seller in connection with the buyers acquisition of the purchased goods. The buyer at either no cost or reduced cost provides the assist to the seller (or parties related to the seller).

If the assist is in the form of goods (hereinafter “assist goods”), either the buyer 101 or another source related to the buyer ships 107 the assist goods to the seller 103. Typically the shipment of assist goods will pass through customs 109 in the second country, potentially leading to the payments of customs duties in the second country. Included among the potential types of assist goods are: materials, components, parts and similar items incorporated in the purchased goods; tools, dies, molds and similar items used in the production of the purchased goods; and merchandise consumed in the production of the purchased goods. The value of the assist can include the transportation cost of shipping the assist goods to the seller.

If the assist in the form of services (hereinafter “assist services”), the buyer provides the assist services to the seller through whatever means are appropriate. Included among the potential types of assist services are: engineering, development, artwork, design work, plans and sketches, unless an employee or agent of the buyer performs these services, within the buyer's country, incidental to the other engineering, development, artwork, design work, planning or sketching activities. The value of the assist can include the cost temporarily relocating workers to be of direct assistance to the seller.

Use of a Customs System

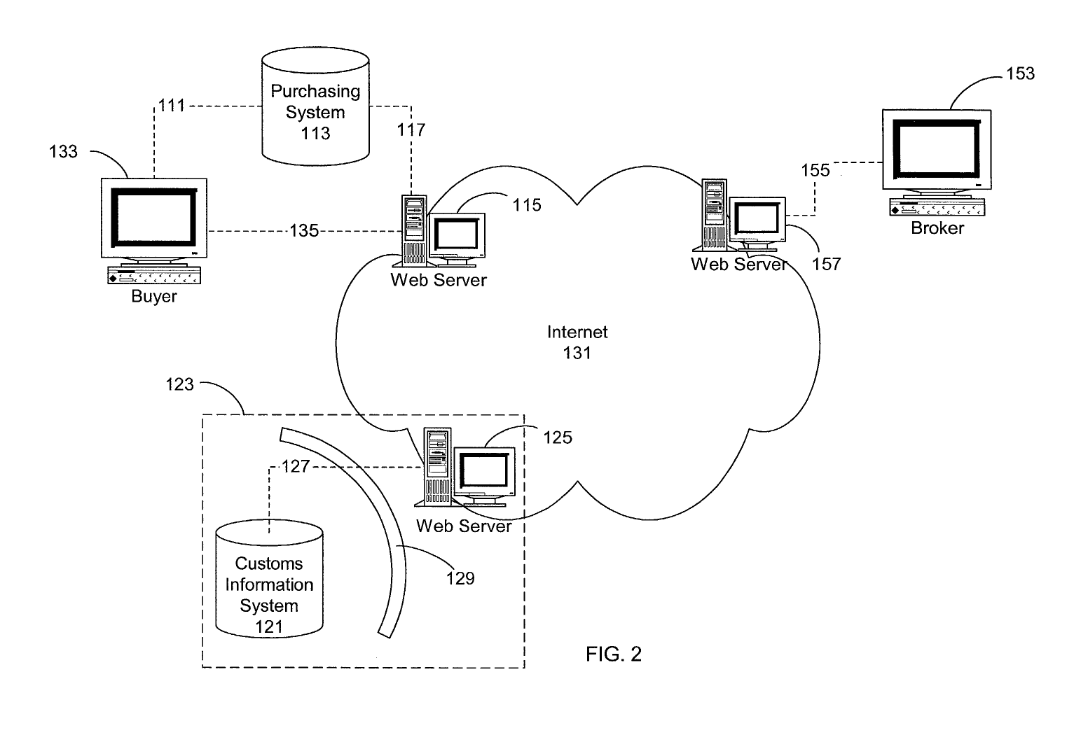

With reference to FIGS. 1 and 2, preferably while arranging for the assist goods and/or services to be given, the buyer 101 preferably enters 111 transaction information into purchasing software on a purchasing system 113. The purchasing system can include a variety of different programs running on different computers, each potentially dealing with different issues of finance, accounting, procurement, logistics and resource management. The components of the purchasing system can communicate (i.e., transmit and receive communications) with each other and other systems via a web server 115, or using other types of network architecture.

The transaction information typically includes part numbers for the purchased parts, the quantity of each part purchased, and the price for which each part was purchased, along with a manufacturer ID (i.e., the identity of the seller), transaction dates, financial terms, and the like. The purchasing system 113 is preferably configured to identify and download 117 information relevant to customs into a customs information system 121. Additionally, the transaction information could include a buyer ID if the embodiment of the invention is configured to simultaneously support a plurality of buyers. As an alternative to the purchasing system downloading the transaction information, the transaction information could be entered at a later time by a broker of a customs brokerage, as described below.

Preferably, the buyer 101 directly accesses the customs information system 121 to enter customs information relevant to the provided assists (hereinafter, “assist information”). The assist information is preferably stored in records separate from the transaction information. For each assist, this assist information will typically include at least a part number, a country-of-origin (i.e., the seller's country), and a value for the assist. Preferably the information will further include information identifying the type of assist, the date it was provided, and possibly an identification of the buyer and the manufacturer to whom the assist was provided (i.e., the seller). Alternatively, the assist information could indicate a particular part of a transaction downloaded by the purchasing software that provides much of the above-identified information, along with a value for the assist.

The customs information system 121 is preferably part of larger computer system 123 including a web server 125 that places the customs information system in communication with the internet. The customs information system transmits and receives 127 communications to its related web server 125 through a firewall 129 to communicate with other computer systems via the internet 131. The owners and/or operators of the customs information system are not in the same corporate family as either the buyer 101 or the customs brokerage. However, various combinations of the buyer, the brokerage and the owner and/or operators, including any two or all three, are within the scope of other preferred embodiments. Furthermore, the customs brokerage and the owner and/or operators could both be groups or divisions within the buyer.

Personnel of the buyer preferably use a computer 133 running an internet browser to transmit and receive 135 communications containing the assist information via the internet to the customs information system 121. The buyer's computer 133 will typically connect to the internet 131 via a web server, which might be the same web server 115 as used by the purchasing system 113. The purchasing software, if it is used, will typically be on a computer directly or indirectly networked with the buyers computer, and will be capable of communicating with the customs information system, such as via the internet.

One or more assists are provided to the seller 103 by the buyer 101. Preferably using the assists, the seller designs, manufactures, assembles, produces and/or otherwise obtains the purchased goods. The seller then ships some or all of the purchased goods to the buyer, causing these shipped goods to be transported 141 across the first country's border 143 to the storage facilities of the first county's customs authority 145.

When purchased goods are received by the customs authority of the buyer's country, a customs brokerage 151 engaged by the buyer 101 is notified. The customs broker then accesses the appropriate customs information in the customs information system 121. In particular, personnel of the brokerage (i.e., a broker) use a computer 153 running an internet browser to transmit and receive 155 communications, via the internet 131, with the customs information system 121. The computer 153 will typically connect to the internet via a third web server 157.

The broker will preferably investigates records of the customs information system 121 to find out if information on the transaction was already downloaded 117 into the customs information system by the purchasing system 113. If no transaction information was downloaded by the purchasing system, then the broker proceeds to enter the transaction information into the customs information system from the commercial invoice, shipping manifest, and other related shipping documents. If transaction information appears to have been downloaded into the customs information system, then the broker verifies the transaction information, correcting and errors and/or adding any omitted portions of the transaction.

The broker also preferably investigates whether customs-specific customs information, such as the customs classification or indications of a special program (e.g., NAFTA), are entered and complete. If no customs-specific customs information was previously entered, then the broker proceeds to determine and enter the customs-specific customs information into the customs information system. If the customs-specific customs information appears to have been previously entered into the customs information system, then the broker verifies that information, correcting and errors and/or adding any omitted information.

The broker also preferably investigates whether the commercial invoice and related documents, or any other information in the possession of the broker, contain any indication that one or more assists were provided by the buyer to the seller. If such indications are located by the broker, then the broker queries the customs information system to see if it contains that assist information. If the customs information system does not contain any indication of the assist, then the broker proceeds to enter the assist information into the customs information system. If the customs information system contains the assist information, but the assist information contains one or more errors or omissions, then the broker corrects the errors and/or adds the omitted information.

Once the broker is satisfied that the customs information system contains all of the correct customs information, the broker instructs the customs information system to send the complete customs information for the transaction to the customs broker for submission to the customs authority. The customs information system then transmits all transaction information and customs-specific customs information relevant to the transaction (or transactions) requested in the send instruction. Also, for each part in the transaction, an assist calculation engine within the customs information system gathers all assist information having the same combination of part number and country-of-origin.

Optionally, for each part in the transaction, the assist calculation engine could gathers all assist information having the same combination of part number, country-of-origin and manufacturer ID. This would allow for assists to be applied to the correct shipments when more than one seller in a given country is used. Additionally, a buyer ID could be part of the combination for customs information systems serving more than one buyer.

Depending on whether the buyer prefers claiming assists proportionally all-at-once, the assist information is sent with its full value or with a proportional value. As a result, the assist calculation engine uses one or more routines configured to identify the assist information associated with the transaction information of any given transaction, and sends that assist information with the rest of the customs information to make a complete package of customs information. Thus, the customs information downloaded by the broker after initiating a “send-for-submission” by the customs information system, includes complete transaction information, customs-specific information and assist information.

Preferably, the preparation of the final customs documents only entails the addition of various required information, such as broker identification information and/or duty payment information (e.g., the source of funds to be used for duty payment), to the customs information. Finally, the broker submits 161 the customs information as customs documents to the customs authority 145. The submission can take various forms, such as a paper submission or an electronic submission. Presuming the customs authority 145 is satisfied with the submitted customs information, the shipped goods are released and allowed to be transported 163 to the buyer and/or a party related to the buyer.

Operation of the Customs System

With reference to FIGS. 1-3, the firewall 129 of the customs system 123 typically screens all communications to the customs information system 121. This is preferably true in alternative network architectures, such as where the buyer and/or the customs broker connect to the customs system via an intranet rather than the internet 131 (e.g., where the buyer, the broker and/or the operator of the customs information system are part of the same corporate family).

The customs information system 121 preferably includes a first set of records 171 representing different transactions, each transaction being all or part of an agreement such as the agreement 105 between the buyer 101 and the seller 103. The first set of records preferably is configured to contain transaction information such as one or more part numbers, and customs-specific information such as part classifications. More preferably, the part numbers are buyer part numbers that uniquely identify the type of part being purchased with respect to all other parts that the buyer purchases. The first set of records also preferably includes a record of the identity of the seller and its country, as well of the buyer and its country if more than one buyer uses the customs information system. All this information is generally useful in determining the duties required to be paid.

The customs information system 121 preferably also includes a second set of records 173 representing different assists provided for the manufacture of parts of a given part number related to a given transaction, each transaction being all or part of an agreement such as the agreement 105 between the buyer 101 and the seller 103. More preferably, the second set of records includes a part number corresponding to part numbers in the first set of records, and a record of the identity of the buyer and the seller and their respective countries. Preferably, but not necessarily, records in the second set of records all relate and/or be keyed to transactions recorded in records of the first set of records, providing for the appropriate assist information to be delivered to the broker with the transaction information.

As described above, after the purchase agreement is first reached, it is preferable for the buyer 133 promptly to enter or otherwise set up the transaction information in the first set of records 171 via the purchasing system 113, and enter all assist information in the second set of records 173. To the extent that classification information is available in a database, the information in the first set of records can be made to include information on customs classification of the product. Preferably the second set of records includes the legal identity of the buyer, seller and related parties of legal interest, information regarding relevant health, safety and environmental requirements for importation, and any other information that might be required by the customs authority.

The information in the second set of records can be identified by numerous sources within the buyer, and need not be entered strictly by the personnel arranging the transaction. For example, to identify assists, buyer personnel in procurement can check transactions for price quotations, purchase orders, cash transfers, supplemental payments and amendments. Likewise, buyer personnel in finance can check reports for dutiable items relating to development, tooling, engineering, materials and the like. Buyer personnel in manufacturing can identify production line transfers, equipment and tooling transfers and/or foreign engineering. Buyer personnel in research and development can check for foreign engineering, equipment, tooling, fixtures, design and co-development projects. Buyer personnel in logistics can watch for international no-charge shipments. All such personnel can either enter assist information themselves or, more preferably, have communication with the personnel arranging the transaction to notify them of the assist being potentially missed in the second set of records.

Because different companies will have different organizational structures, the precise selection of such assist checkpoints in the organization can vary. Nevertheless, it is preferable that the buyer has in place one or more such checkpoints where personnel not directly related to the individual transaction (i.e., personnel neither involved in negotiating and making the transaction, nor involved in receiving the purchased goods) watch for indications of assists that might otherwise go unnoticed.

The customs information system 121 can be configured to have the broker 151 claim the assist in whatever manner the buyer prefers (within the allowed legal possibilities). For example, the buyer might prefer to claim the full value of the assist against the first shipment of the purchased goods, regardless of the value of the assist used in creating that first shipment, or perhaps regardless of which seller manufactured the goods from a given country. Alternatively, the buyer might prefer to apportion the value of the assist over the full number of goods produced by the seller. In the later case, the assist records would likely further include fields for tracking the total number of parts over which to divide the assist value and the number of parts already claiming the prorated assist value.

The customs information system is configured such that the buyer's preference of assist-claiming methodology can be input by the buyer when the customs information is first entered into the first set of records. However, the customs information system can optionally allow that preference to be overridden on a case by case basis for each assist, allowing for undepletable assists (such as engineering assistance) to be claimed with the first shipment of purchased goods, while depletable assists (such as parts incorporated into the purchased goods) can be apportioned over the full set of relevant purchased goods.

For each part, the customs information system 121 is preferably configured to establish a duty rate. The assists for that part are then assessed duty at that same established rate. Per typical customs requirements, the assists will be claimed even if the purchased goods are duty free.

Entry and Monitoring of Assist Information

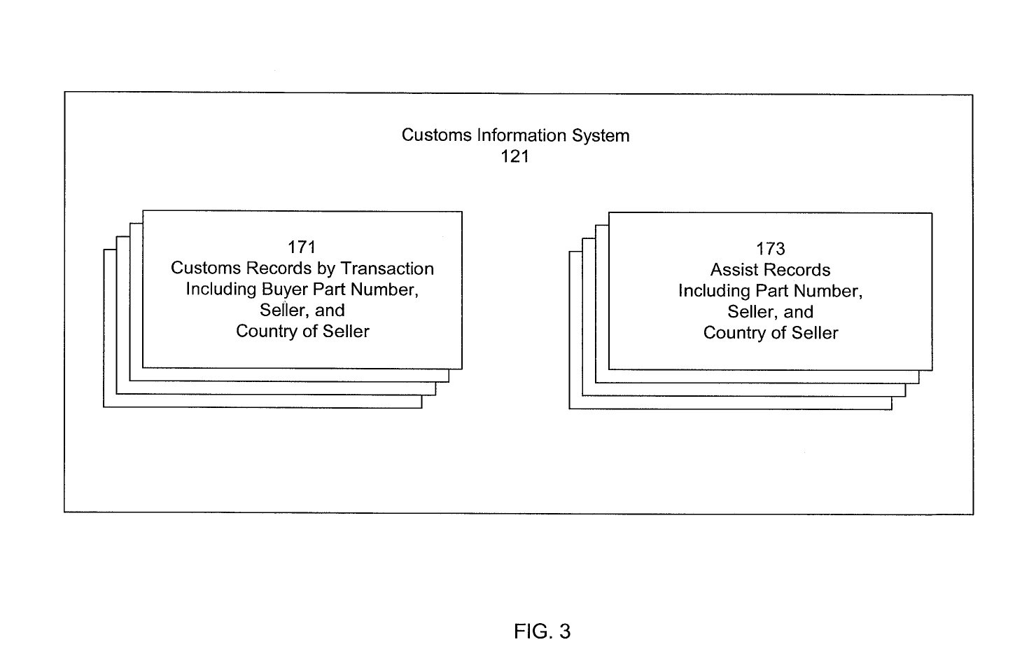

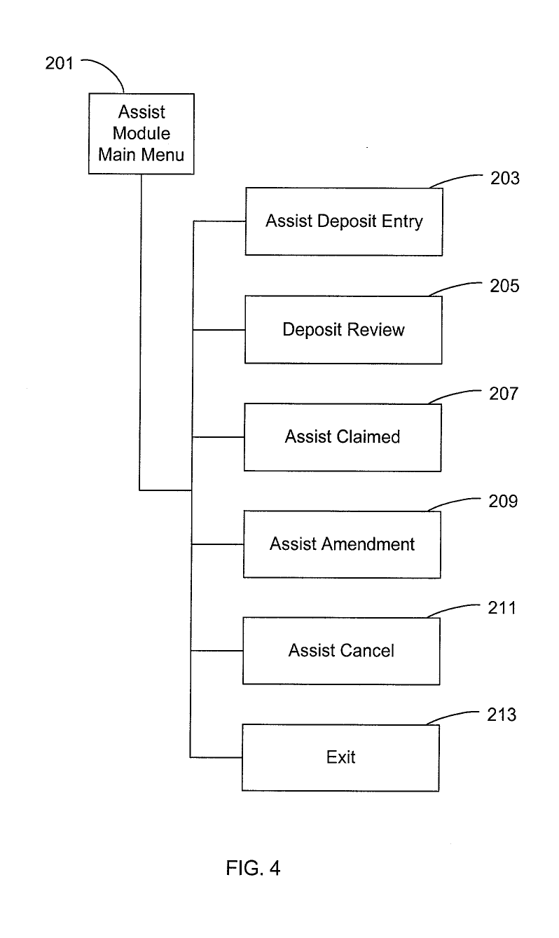

With reference to FIGS. 3 and 4, the second set of records 173 operates with a checkbook-like functionality. In particular, each combination of part number and country-of-origin operates as a separate account, with each entered assist being treated as a deposit and each customs claim being treated as a withdrawal. Optionally, the account could be identified by the combination of the part number and the manufacturer, the part number and both the country-of-origin and the manufacturer, or some other appropriate combination.

The second set of records 173 are accessed via an assist module (depicted in FIG. 4). The assist module includes a Main Menu 201, and subsequent screens for Assist Deposit Entry 203, Deposit Review 205, Assist Claims 207, Assist Amendment 209, and Assist Cancellation 211. Exiting 213 the assist module is of course another option from the Main Menu.

The Assist Deposit Entry 203 screen is used by a user to enter assist activity information for declaration on future import entries. Preferably, the Assist Deposit Entry screen requires the entry of a country-of-origin code, the identifier of the assist provider, an order or part number associated with the particular agreement or transaction, and values for each type of assist being claimed. Optionally, the assist module could require that an order or transaction be downloaded or entered into the first set of records prior to recording assists for that particular order or transaction.

The Assist Deposit Review 205 screen is configured to access the second set of records 173, providing for a review of assist balances or assist activity information by order, transaction or combination of part number and country-of-origin. This screen might be accessible by many personal who do not have write-access to the Assist Deposit Entry screen.

The Assist Claimed Screen 207 provides a user with the ability to enter assist withdrawals when an assist is properly declared on any import entry. The user will typically be a customs broker. This screen will typically require entry of an assist amount and a corresponding entry number.

The Assist Amendment Screen is used by a user to amend a previously entered assist. Preferably, this screen cannot be used to amend key information such as the part number or country-of-origin. Rather than replacing the original assist deposit record, this screen results in an amending record that is saved in the second set of records.

The Assist Cancel 211 screen is used by a user to cancel a previous deposit entered into the assist module. This cancellation will typically be caused by either an erroneous entry or a changing business environment. Rather than deleting the original assist deposit record, this screen results in an amending record that is saved in the second set of records.

Optionally, the module can include an Assist Suspended Withdrawal screen intended for use by a broker to enter assist activity listed on a commercial invoice, but not already indicated in the second set of records 173 as a deposit. Typically this screen will at least require the entry of a country-of-origin code, identification of the buying entity, an assist amount claimed, and entry number, the date of entry and the port of entry.

Preferably, users of the assist module will receive separate notification of certain activities to confirm their entry. For example, users using the amendment or cancel functions will preferably receive an email message confirming this activity. Additionally, the user who entered the original record will preferably be copied on this email message. Also, a process owner who is in charge of the operation of the database, or at least in charge of the assist records, could receive notification of all assist entry activity. Optionally, the assist module will also include ad hoc report functionality to monitor the second set of records 173 better.

It is to be understood that the invention comprises various apparatus, systems and methods for tracking and applying customs assistance information on customs documentation. Additionally, various embodiments of the invention can incorporate various combinations of the above-described features. In short, the above disclosed features can be combined in a wide variety of configurations within the anticipated scope of the invention.

Furthermore, embodiments of the invention can be incorporated into various systems and methods, and can incorporate elements of various customs systems and methods as described in U.S. patent application Ser. No. 09/971,878, which is incorporated herein by reference for all purposes.

While particular forms of the invention have been illustrated and described, it will be apparent that various modifications can be made without departing from the spirit and scope of the invention. For example, a customs information database can be customized to an individual buyer or an individual customs brokerage, potentially eliminating the tracking of certain information (e.g., the identity and/or country of the buyer), or potentially adding additional functionality (e.g., the automatic addition of a broker identification and payment information to the customs information. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claims.

We claim:

1. A system for a broker of a customs brokerage to generate customs documents for a transaction in which a buyer the imports purchased goods from a seller, comprising:
a customs information system database including a first set of records configured to contain transaction information identifying the purchased goods, and including a second set of records configured to contain assist information identifying a value for assistance provided by the buyer to the seller as part of the transaction;
wherein the database is configured to be in electronic communication with the buyer such that the buyer can enter assist information for the transaction in the second set of records;
wherein the database is configured to be in electronic communication with the broker such that the database can send transaction information from the first set of records, to the broker, for generating customs documents for the transaction; and
wherein the database is configured to automatically send the assist information for the transaction to the broker along with the transaction information.

2. The system of claim 1, wherein the database is configured such that the broker can enter transaction information into the first set of records.

3. The system of claim 1, wherein the database is configured such that the buyer can enter transaction information into the first set of records.

4. The system of claim 3, wherein the database is configured such that the buyer can enter transaction information indirectly via entering information into purchasing software.

5. The system of claim 1, wherein the database is configured such that the broker can enter assist information into the second set of records.

6. The system of claim 1, wherein the brokerage and buyer are not part of a common corporate family.

7. The system of claim 1, and further including a web server and firewall configured to support the communication with the buyer and the customs broker.

8. The system of claim 1, wherein the second set of records are configured to track assists claimed on customs documents in amounts proportional to the percentage of assisted goods passing through customs.

9. The system of claim 1, wherein the customs information system database includes a routine configured to identify assist information associated with a given combination of part number and country-of-origin.

10. A method for a broker of a customs brokerage to generate customs documents to be submitted to a customs authority in the support of a transaction wherein a buyer imports purchased goods from a seller, comprising:
retrieving information, including both transaction information identifying the purchased goods and assist information identifying a value for assistance provided by the buyer to the seller as part of the transaction, from a customs information system database having a first set of records containing the transaction information and a second set of records containing the assist information; and
generating customs documents from the transaction information and the assist information retrieved in the step of retrieving;
wherein the database is configured to be in electronic communication with the buyer such that the buyer can enter assist information into the second set of records.

11. The method of claim 10, wherein the step of retrieving includes:
requesting the database to send transaction information for the transaction;
receiving the requested transaction information; and
automatically receiving related assist information with the received transaction information.

12. A method for a buyer to provide information to a broker of a customs brokerage such that the customs broker can generate customs documents to be submitted to a customs authority in the support of a transaction wherein the buyer imports purchased goods from a seller, comprising:
identifying a value for assistance provided by the buyer to the seller in support of the sellers production of the purchased goods as part of the transaction; and
submitting assist information, including the identified value for assistance provided by the buyer to the seller, to a customs information system database configured with a first set of records configured to store transaction information and a second set of records configured to store the assist information;
wherein the database is configured to be in electronic communication with the broker such that the broker can retrieve transaction information from the first set of records and assist information from the second set of records.

13. The method of claim 12, and further comprising entering transaction information into the first set of records.

14. The method of claim 13, wherein the step of entering transaction information comprises inputting transaction information into purchasing software.

15. The method of claim 12, wherein the database includes a routine configured to automatically send associated assist information along with transaction information when the broker requests transaction information for the transaction to generate customs documents.

16. A method for a buyer and a customs broker to cooperatively generate customs documents to be submitted to a customs authority in the support of a transaction wherein the buyer imports purchased goods from a seller, comprising:
identifying a value for assistance provided by the buyer to the seller as part of the transaction;
submitting transaction information, including an identification of the goods purchased in the transaction to a customs information system database, the database having a first set of records configured to contain transaction information;
submitting assist information, including the identified value for assistance provided by the buyer to the seller, to the database, the database also having a second set of records configured to contain assist information;
retrieving both the transaction information and the assist information associated with the transaction from the database; and
generating customs documents from the transaction information and assist information retrieved in the step of retrieving.

17. The method of claim 16, wherein the step of retrieving includes:
requesting the database to send transaction information for the transaction;
receiving the requested transaction information; and
automatically receiving related assist information with the received transaction information.
